(19) United States
(12) Patent Application Publication
(10) Pub. No.: US 2003/0041808 A1
(43) Pub. Date: Mar. 6, 2003

(54) Odor absorbing animal bed and method

(76) Inventors: Christopher Carl Wulforst, Boiling Springs, SC (US); Kyle Garrod Gipson, Simpsonville, SC (US); Duff Bernard Wagner, Taylors, SC (US)

Correspondence Address: Jeffery E. Bacon, Legal Department, M-495, Milliken & Company, PO Box 1926, Spartanburg, SC, 29304, US

(21) Appl. No.: 10/207,519

(22) Filed: Jul. 29, 2002

Related U.S. Application Data
(63) Continuation-in-part of application No. 09/940,744, filed on Aug. 28, 2001.

(51) Int. Cl. A01K 29/00

(52) U.S. Cl. 119/28.5

(57) ABSTRACT

An animal bed having an cushioning core material surrounded by an encasing. The encasing has a face textile disposed in contacting relation across and odor adsorbing layer. The odor adsorbing layer includes a odor adsorbing agent adhered to an interior of the face textile. A related method is also provided.

### CROSS-REFERENCE TO RELATED APPLICATION

This Application is a continuation-in-part of co-pending, prior application Ser. No. 09/940,744 having a filing date of Aug. 28, 2001 the contents of which are incorporated by reference herein in their entirety.

### BACKGROUND AND SUMMARY

The present invention relates to bedding articles for animals, and in particular to bedding articles for odor control.

Animal bedding provides a surface for an animal, such as a pet to rest upon which is typically more comfortable than the ground or conventional floors. However, the repeated use of such beds by animals can create odors on and in the bed. Therefore, there is a need for animal beds which can reduce or control odors.

The present provides a covering material for an animal bed such as a pet bed or the like which includes an odor adsorbing material.

### BRIEF DESCRIPTION OF THE DRAWINGS

The invention will now be described by way of example only through reference to the accompanying drawings which are incorporated within and which constitute a part of this specification and in which:

FIG. 1 is a perspective view of an exemplary animal bed incorporating an odor receiving covering;

FIG. 2 is a partial cross sectional view of an animal bed having a first exemplary construction;

FIG. 3 is a view similar to FIG. 2, illustrating a second exemplary construction; and

FIG. 4 is a enlarged partial cross sectional view of an exemplary embodiment of a covering material for an animal bed.

While the invention has been generally described above and will hereinafter be described in detail in connection with certain potentially preferred embodiments, it is to be appreciated that the foregoing general description as well as the particularly illustrated and described embodiments as may be set forth herein are intended to be exemplary and explanatory only. Accordingly, there is no intention to limit the invention to such particularly illustrated and described embodiments. To the contrary, it is intended that the present invention shall extend to all alternatives, modifications and equivalents as may fall within the broad principles of the invention within the full spirit and scope thereof.

### DETAILED DESCRIPTION

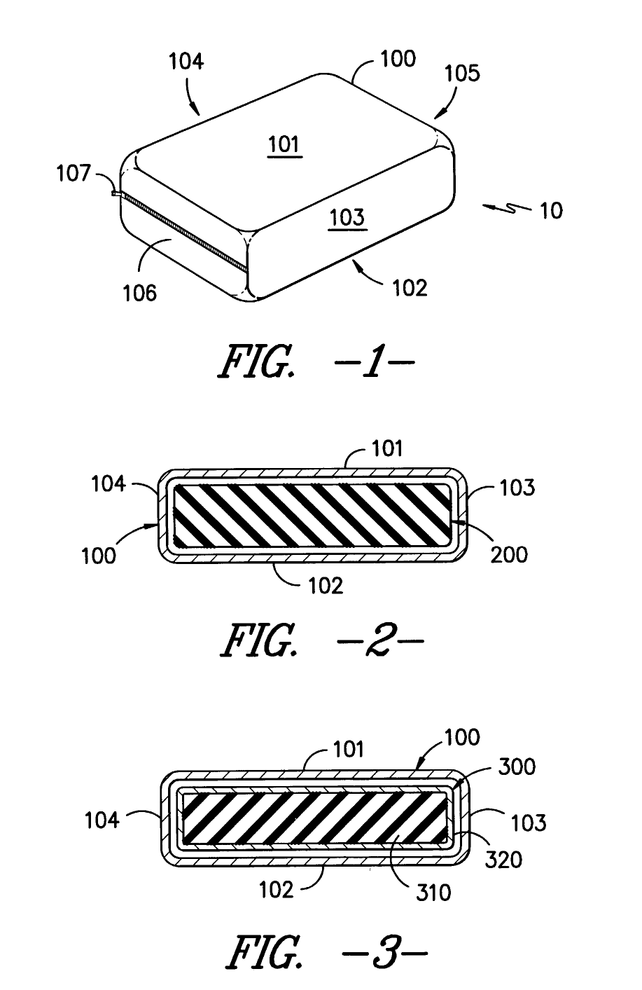

Referring now to the drawings, and in particular to FIG. 1, there is illustrated an animal bed 10 such as may be used to support a pet or other animal during a resting period. According to the illustrated exemplary embodiment the animal bed 10 includes an encasing 100. The encasing 100 has a top surface 101, a bottom surface 102, side walls 103, 104, and 105, and an enclosure end 106 with a closure member 107. The closure member 107 can be a zipper closure member, a hook and pile closure member, a series of buttons and button holes, or the like to facilitate periodic removal of the encasing 100 for laundering or other treatment. Although the animal bed 10 has been illustrated in FIG. 1 as a square-pillow type configuration, it is understood that the animal bed 10 can be any shape that will accommodate an animal which would rest on the animal bed 10. Likewise, it is to be understood that the encasing 100 need not be removable and may be permanently disposed in surrounding relation to a cushioning inner core structure as will now be described in further detail.

Referring now to FIG. 2, there is shown a partial cross sectional view of one embodiment of the animal bed 10 illustrated in FIG. 1. As illustrated in FIG. 2, the animal bed 10 includes the encasing 100 surrounding a core 200. The core 200 is preferably a cushioning material, such as foam, an assemblage of natural or synthetic fibers such as cotton fiber, polyester fiber, and polypropylene fiber, straw, chipped or shredded cedar wood or the like.

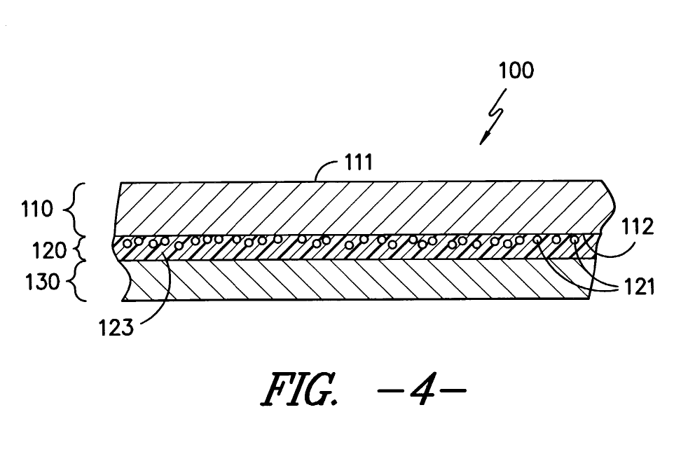

Referring now to FIG. 3, there is shown a partial cross section of the animal bed 10 in FIG. 1, having the encasing 100 surrounding a core 300. As illustrated in FIG. 3, the core 300 includes a cushioning material 310 surrounded by a lining 320. The cushioning material 310 can be a foam, an assemblage of natural or synthetic fibers such as cotton fiber, polyester fiber, and polypropylene fiber, straw, chipped or shredded cedar wood or the like.

The lining 320 can be a material such as plastic, natural or synthetic rubber, a textile material of nonwoven construction, a textile material of woven construction, a textile material of knitted construction, or the like including combinations of any of the aforementioned materials. By way of example only and not limitation, in some applications it may be desirable 320 be substantially liquid impermeable to prevent migration of bodily fluids from a pet into the core 300.

Referring now to FIG. 4, there is shown an enlarged partial cross sectional view of the encasing 100. According to the illustrated exemplary construction, the encasing 100 generally includes a face textile 110 and an odor receiving layer 120. The face textile 100 has an exterior surface 111 and a interior surface 112. The odor receiving layer 120 is typically disposed on the interior surface 112 of the face textile 110. In one embodiment, the encasing 100 can include a backing material 130 disposed adjacent to, and protecting, the odor receiving layer 120.

It is contemplated that the face textile 110 may be of any known construction including a knit construction, a woven construction, a nonwoven construction, or the like. The material of the face textile 110 can be a synthetic material, a natural material, a man-made material using natural constituents or a blend of any of the foregoing. By way of example only and not limitation, it is contemplated that exemplary synthetic materials useful for the face textile 110 may include polyester, polypropulene, nylon, acrylic and the like including blends thereof. It is contemplated that exemplary natural fibers used for the face textile 110 may include cotton, linen, jute, ramie, wool and the like including blends thereof. Exemplary man-made materials using natural constituents include rayon, lyocell and the like including blends thereof.

While the face textile 110 is illustrated as a single layer, it is likewise contemplated that the face textile may also be a multi-layer construction if desired. By way of example only and not limitation, in one embodiment the face textile 110 is a single layer 100% polyester warp knit pile fabric having a weight in the range of about 3 to about 9 ounces per square yard. According to another exemplary construction the face textile 110 is a single layer 100% polyester circular double knit fabric having a weight in the range of about 1 to about 5 ounces per square yard.

It is contemplated that the exterior surface 111 of the face textile 110 can be treated to provide a more desirable surface, both in feel and performance. For example, it is contemplated that the face material 110 may be subjected to various mechanical surface treatments either independently or in combination with various chemical surface treatments as described further hereinafter so as to develop a desired feel and/or patterning effect. By way of example only, and not limitation, one contemplated mechanical surface treatment as may be utilized is calendering wherein the face textile 110 is passed under pressure between calender rolls so as to provide a generally smooth surface finish. Another contemplated mechanical surface treatment as may be utilized is embossing wherein calendering is carried out using heated engraved rolls so as to impart a pattern across the exterior surface 111. Another contemplated mechanical surface treatment as may be utilized is metalization or sputtering wherein thin layers of metallic materials are selectively deposited across the exterior surface 111. Still another contemplated mechanical surface treatment as may be utilized is heat setting wherein the face textile 110 is subjected to an elevated temperature under tension or pressure to improve dimensional stability, heat resistance and wrinkle resistance. Another contemplated mechanical surface treatment as may be utilized is sanforizing wherein mechanically induced shrinkage is introduced into the face textile 110 by application of a compressive force so as to improve dimensional stability and hand. Yet another contemplated mechanical surface treatment as may be utilized is glazing wherein the face textile 110 is treated with a starch, paraffin, synthetic resin or the like within a friction calender so as to produce an exterior surface 111 of smooth highly polished character. Another contemplated mechanical surface treatment as may be utilized is schreinering wherein the face textile 110 is calendered with a series of raised substantially invisible ridges across the exterior surface 111 so as to increase the surface for light reflection. Another contemplated mechanical surface treatment as may be utilized is sueding wherein the face textile 110 is passed in contacting relation with rapidly revolving rollers covered with abrading material to provide a soft smooth exterior surface 111. As will be appreciated, sueding may include sanding wherein the revolving rollers are covered with sandpaper or the like to yield a raised pile. Sueding may also include emerizing wherein the revolving rollers are covered with emery to yield a smooth nap of slightly shorter height. Yet another contemplated mechanical surface treatment as may be utilized is napping wherein surface fibers are raised across the exterior surface 111 by contact with revolving cylinders covered with wires or burrs. It is contemplated that such napping processes may produce a slightly longer nap than sanding which may be desirable in some applications. Another contemplated mechanical surface treatment as may be utilized is shearing wherein the face textile 110 having a pile surface is trimmed to a defined pile height. As will be appreciated, such shearing may be carried out following a sueding or napping operation to provide a smooth exterior surface 111 of defined height. Still another contemplated mechanical surface treatment as may be utilized is tigering which involves removing surplus strands of fiber from the surface of high pile fabrics and setting the piles. Tigering may be used following a sueding or napping operation or may be carried out on a fabric such as a plush fabric which is formed with a naturally occurring pile. Another contemplated mechanical surface treatment as may be utilized is decating, which involves steaming the face textile 110 between press cloths to improve dimensional stability luster and hand. Still another contemplated mechanical surface treatment as may be utilized is crepe fabric patterning wherein the face textile is crinkled or grained to obtain surface effects. Exemplary processes for carrying out such crepe fabric patterning may include application of high pressure air or water jets or the use of patterned rolls.

It is also contemplated that the face textile 110 may be treated with so called “anti-microbial agents” also known as “microbe-inhibiting agents” to inhibit microbe and/or fungal growth. Such anti-microbial agents are typically based on metallic systems such as copper, silver and the like which impede or prevent the growth of microorganisms. Exemplary anti-microbial agents are identified in U.S. Pat. No. 6,196,156 to Denesuk et al. the teachings of which are incorporated by reference in their entirety as if fully set forth herein.

It is further contemplated that other chemical surface treatments may also be utilized either alone or in combination with one another and/or in combination with anti-microbial agents to impart desired physical performance properties. By way of example only and not limitation, such chemical surface treatments may include the application of fire retardant agents, UV inhibiting agents, water resisting agents, stain resisting agents, coloring agents, fragrances, anti-static agents or the like. For example, it is contemplated that a fluorochemical treatment such as SCOTCHGUARD®) or the like available from Minnesota Mining and Manufacturing Company can be applied to the outer surface 111 of the face material 110 either alone or in combination with other surface chemical treatments to inhibit stains and to repel water. It is also contemplated that a so called “soil release agent” may be applied either alone or in combination with other surface chemical treatments to aid in the cleanability of the face material during a laundering operation. One such soil release agent is believed to be commercially available under the trade designation VISA® by Milliken Chemical having a place of business in Spartanburg, S.C. Such soil release agents may also impart the added features of improving initial staining resistance and reducing moisture wicking which may be beneficial in some instances.

It is also contemplated that various polymeric coating compositions may be applied to the outer surface 111 to increase liquid resistance. Such polymeric coating compositions may be applied alone or in combination with other agents including fluorochemical, soil release, and anti-microbial agents as may be desired. By way of example only, it is contemplated that such polymeric coating compositions may include polyolefins, polyamides, polyesters, polyurethanes, acrylics and combinations thereof.

While the outer surface 111 may be substantially plain in appearance having a generally solid color (either with or without embossed patterns) corresponding to the color of the material making up the face textile 110, it is also contemplated that the outer surface may be colored by either a solid or patterned dye application. In the event that a solid color is desired, it is contemplated that the face textile 110 may be subjected to a dye bath either before or after the application of any topical surface treatment. Alternatively, it is contemplated that the face textile 110 may be formed from so called “solution dyed” synthetic fiber such as solution dyed polyester or the like wherein a pigment or dye is mixed intimately with the polymer forming the fibers of the face textile 110.

In some applications it is contemplated that patterned printing may be beneficial to impart aesthetically pleasing patterned designs. Such designs may also provide the added benefit of partially obscuring food and waste stains which may result during prolonged use. Various printing techniques which may be utilized to apply patterned designs include transfer printing, screen printing, flexographic printing, digital printing and ink jet printing. It is contemplated that screen printing may be particularly useful in the production of large quantities of material with similar patterns. Transfer printing may be particularly useful in the repeating production of material with the same pattern. In practice, such transfer printing is carried out by applying a color design to a paper carrier and thereafter transferring the design from the carrier to the fabric under heat and pressure such as at a roll press which introduces a calendering effect to the fabric.

The odor receiving layer 120 will contain an odor receiving agent 121 for attracting and holding odors. The odor receiving agent can be an odor absorbing agent, and/or an odor adsorbing agent. Odor absorbing agents receive the odor and trap that odor inside the agent. Odor adsorbing agents receive the odor and hold the odor on the exterior of the agent. The odor adsorbing agent has the added advantage that odor can be released and the agent refreshed for additional use if the agent is subjected to heat, such as from a clothes dryer.

The odor receiving agent of the odor receiving layer 120 is preferably a particulate odor receiving agent such as activated carbon or charcoal, zeolite compound, or the like. Particulate odor receiving agents provide a greater surface area for receiving the odorous material. Carbonaceous materials that can be converted into an activated carbon or charcoal for the present invention include materials such as coal (bituminous), coconut shells, coke, peat, petroleum fractions, wood chips (saw dust), or the like. Other less common materials that can be used for forming activated carbon or charcoal include automobile tires, cherry stones, coffee grounds, corn cobs, plastic waste, sewage sludge, straw, water lilies, or the like. Performance of the activated carbon or charcoal is typically improved with greater pore size and surface area. Generally, the smaller the particulate size, the better the odor receiving capability of the odor receiving agent. One material which is contemplated for use is an activated charcoal product marketed under the trade designation GARFIL™ by Purification Products, Ltd. of Great Britain. In one embodiment, the odor receiving agent in the form of activated charcoal has a 100×150 mesh screened particle size and is distributed below the interior surface 112 of the face textile 110 at a rate of from about 1.5 ounces per square yard to about 3 ounces per square yard. In another embodiment, the activated charcoal has a 50×100 mesh screen particle size.

The odor receiving agent 121 of the odor receiving layer 120 can be disposed adjacent to the interior surface 112 of the face textile 110 and/or may be disposed adjacent to the backing material 130 and/or may be disposed at an intermediate location between the face textile 110 and the backing material 130. According to a potentially preferred practice, it is contemplated that at least a substantial portion of the odor receiving agent 121 is disposed in contacting relation across at least a portion of the interior surface 112 of the face textile 110 so as to promote odor collection from the exterior surface 111. Additionally, the odor receiving agent can be disposed across the same entire area as the face textile 110, or only in select areas and or positions of the area of the face textile 110.

By way of example only and not limitation, it is contemplated that the odor receiving agent 121 ay be secured in position below the face textile 110 by an adhesive or binder 123 in cooperative relation with the odor receiving agent 121. It is contemplated that the adhesive or binder 123 securing the odor receiving agent 121 in place can be a thermoplastic film or meltable fabric. In one embodiment, the adhesive 123 is a film of heat activatable thermoplastic adhesive. According to one contemplated practice using a film or meltable substrate adhesive, the odor receiving agent 121, such as activated charcoal, can be placed on the interior surface 111 of the face textile 110 and then the adhesive film or meltable fabric is placed on the odor receiving agent 121 and the interior surface 111 prior to the application of heat. Alternatively, the odor receiving agent can be placed on the adhesive film or meltable fabric and then the interior surface 111 of the face fabric 110 placed on the odor receiving agent 121 and adhesive film or meltable fabric prior to the application of heat. In yet another embodiment, the odor receiving agent 121 can be disposed within the adhesive film or meltable fabric. The adhesive film or meltable fabric can be located over the entire area of the face fabric 110, or only over a portion of the face fabric such as a preselected pattern.

It is also contemplated that the binder or adhesive 123 may be either a wet adhesive or a dry heat activatable adhesive such as a powder, low melt fiber or the like. Various construction materials and adhesive systems for use in conjunction with particulate activated carbon or charcoal odor receiving agents are described in U.S. Pat. Nos. 5,383,236 to Sesselmann; 5,154,960 to Mucci et al; and 4,510,193 to Blucher et al. all of which are incorporated by reference as if fully set forth herein. In the event that the adhesive 123 is a wet or dry adhesive, it is contemplated that the particulate odor receiving agent 121 may be blended with the adhesive 123 to form an admixture which is thereafter spread across the interior surface 112. The wet or dry adhesive can be located over the entire area of the face fabric 110, or only over a portion of the face fabric such as a preselected pattern.

In the embodiments where the binder or adhesive 123 is a heat activated material, heat may be applied to the binder or adhesive 123 after the positioning of the of odor receiving agent 121 and the binder or adhesive 123 to activate the adhesive causing attachment to the interior surface 112. It is contemplated that this heat activation may be carried out by either a uniform heating source which activates all adhesive elements or by a directional heat source such as a hot air gun or the like which activates the adhesive elements in a preselected pattern.

It is also contemplated that the odor receiving layer 120 may be a nonwoven fibrous material including an adhesive binding agent such as a thermoplastic adhesive in which particles of activated carbon or charcoal are dispersed. In such a construction the binding agent is preferably a so called “soft binder” having a relatively low glass transition temperature as described in U.S. Pat. No. 5,678,247 the teachings of which are incorporated by reference as if fully set forth herein.

It is to be understood that the odor receiving layer 120 may be disposed over substantially the entire interior surface 112 of the face textile 110. However, it is likewise contemplated that the odor receiving layer 120 can be disposed over the interior surface 112 of the face textile 110 in only selected areas of the encasing 100, such as the top surface 101 area of the encasing 100, or a combination of areas of the encasing 100. Correspondingly, even in areas wherein the odor receiving layer is present, it is contemplated that the odor receiving agent need not cover the entire area but may be dispersed in a patterned arrangement such as dots, stripes and the like so as to further promote flexibility.

In the event that a backing material 130 is utilized, it is contemplated that the adhesive system utilized to hold the particulate odor receiving agent in place within the odor receiving layer 120 below the interior surface 112 may likewise be utilized to establish a bonding relation between the backing material 130 and the odor receiving layer 120. That is, a common adhesive matrix may extend between the face textile 110 and the backing material 130. Of course, as previously indicated, the backing material 130 may be eliminated if desired.

In the event that a backing material 130 is utilized, it is contemplated that such backing material can be either similar or dissimilar to the face textile 110. According to one contemplated construction, the backing material may be a textile of woven, knit, or nonwoven construction although a nonwoven construction such as a spun bonded, point bonded, needle punched, carded web or the like may be preferred. The fibers forming a textile backing material may be of any suitable type including natural fibers, man-made fibers formed from natural constituents or synthetic fibers including, by way of example only and not limitation, cotton, linen, polyester, nylon, acrylic, rayon, polypropylene, polyethylene and blends thereof. In one exemplary embodiment, the backing material 130 is a point bonded nonwoven polyester material, formed of about 2.6 denier per filament and having a weight of less than about 1 ounce per square yard. According to another exemplary embodiment the backing material may be a carded web of polyester staple fibers having a weight in the range of about 0.3 to about 3.5 ounces per square yard and more preferably about 0.5 to about 1.5 ounces per square yard.

It is also contemplated that a backing material 130 in the form of a film such as a liquid impermeable polymer film such as polypropylene, polyethylene, polyester, polyamide or natural or synthetic rubber may also be utilized if desired. According to one contemplated embodiment where the backing material 130 is a film, the film is a low density polyethylene film of about 2 ounces per square yard. In this embodiment, the film of the backing material 130 can be a multilayer film having the adhesive film for securing the odor receiving agent to the face textile 110. In this manner, the application of the adhesive and the backing material 130 can occur under the same step of assembly.

Attachment between the backing material 130 and the face textile is preferably effected by adhesion across the odor receiving layer 120. However, further attachment may be carried out by stitching or patterned welding such as IR (infrared) or RF (radio frequency) welding as will be known to those of skill in the art.

In accordance with the above description, it may be seen that the present invention provides a useful and highly versatile animal bed and covering. It is believed that the present invention may provide particular benefit in the efficient elimination of odors. Surprisingly, in light of such efficient odor elimination it is believed that the addition of microbe-inhibiting agents may no longer be necessary since such materials are typically added in large part to prevent odor generation. Accordingly, it is contemplated that the bed 10 may be formed substantially without the addition of any microbe-inhibiting agent to any component including the core or outer encasing if desired.

While the invention has been illustrated and described in relation to certain exemplary embodiments, it is to be understood that such embodiments are exemplary and illustrative only. Accordingly, there is no intention that the present invention should be limited to any of the illustrated and described embodiments. Rather, it is contemplated that any number of other modifications and variations may become apparent to the skilled practitioner upon review of the present specification and/or through practice of the invention described herein. Accordingly, it is intended to cover all such modifications and variations as may fall within the full spirit and scope of the present invention as defined by allowable claims and all equivalents thereto.

What is claimed is:

1. An animal bed encasing for enclosing a cushioning core, the encasing comprising:
a face textile with an exterior surface and an interior surface wherein the face textile is selected from the group consisting of a woven textile material, a knitted textile material and a nonwoven textile material; and
an odor receiving layer disposed on the interior surface of the face textile, wherein the odor receiving layer comprises a plurality of odor receiving particles selected from the group consisting of activated carbon and activated charcoal held in place by a bonding adhesive and wherein at least a portion of the odor receiving particles are disposed in contacting relation with the interior surface.

2. The animal bed encasing according to claim 1, wherein said face textile material is formed from at least one of the group consisting of: polyester fiber, nylon fiber, acrylic fiber, rayon fiber, cotton fiber, linen fiber, ramie fiber, jute fiber, wool fiber and blends thereof.

3. The animal bed encasing according to claim 1, wherein said face textile material is formed from solution dyed polyester.

4. The animal bed encasing according to claim 1, wherein said face textile includes an anti-microbial agent.

5. The animal bed encasing according to claim 1, wherein said face textile includes a surface agent comprising a fire retardant agent disposed across said exterior surface.

6. The animal bed encasing according to claim 1, wherein said face textile includes a surface agent comprising an ultra violet resisting agent disposed across said exterior surface.

7. The animal bed encasing according to claim 1, wherein said face textile includes a surface agent comprising a water resisting agent disposed across said exterior surface.

8. The animal bed encasing according to claim 1, wherein said face textile includes a surface agent comprising a stain resisting agent disposed across said exterior surface.

9. The animal bed encasing according to claim 1, wherein said face textile includes a surface agent comprising a coloring agent disposed across said exterior surface.

10. The animal bed encasing according to claim 1, wherein said face textile includes a surface agent comprising a fragrance.

11. The animal bed encasing according to claim 1, wherein said face textile includes a surface agent comprising an anti-static agent disposed across said exterior surface.

12. The animal bed encasing according to claim 1, wherein said face textile includes a surface agent comprising a fluorochemical disposed across said exterior surface.

13. The animal bed encasing according to claim 2, wherein said face textile includes a polymer coating disposed across said exterior surface.

14. The animal bed encasing according to claim 13, wherein said polymer coating is selected from the group consisting of; polyolefins, polyamides, polyesters, polyurethanes, acrylics and combinations thereof.

15. The animal bed encasing according to claim 1, wherein the face textile is a printed fabric including a patterned design printed across at least a portion of the exterior surface.

16. The animal bed encasing according to claim 1, wherein the face textile includes a raised nap disposed across the exterior surface.

17. The animal bed encasing according to claim 1, wherein said bonding adhesive is a heat activatable thermoplastic adhesive.

18. The animal bed according to claim 17, wherein said bonding adhesive is disposed in a preselected pattern across the interior surface of the face textile.

19. The animal bed encasing according to claim 1, further including a backing material disposed adjacent to the odor adsorbing layer at a position below the face textile.

20. The animal bed encasing according to claim 19 wherein said backing material comprises a textile material.

21. The animal bed encasing according to claim 20, wherein said textile material is a woven textile structure.

22. The animal bed encasing according to claim 21, wherein said woven textile structure is formed from a plurality of fibers selected from the group consisting of; cotton fibers, linen fibers, polyester fibers, nylon fibers, acrylic fibers, rayon fibers, lyocell fibers, polypropylene fibers, polyethylene fibers and blends thereof.

23. The animal bed encasing according to claim 1, further including a backing material disposed adjacent to the odor adsorbing layer at a position below the face textile, wherein said backing material is a textile material and wherein said textile material is a nonwoven textile structure.

24. The animal bed encasing according to claim 23, wherein said nonwoven textile structure is formed from a plurality of fibers selected from the group consisting of; cotton fibers, linen fibers, polyester fibers, nylon fibers, acrylic fibers, rayon fibers, polypropylene fibers, polyethylene fibers and blends thereof.

25. The animal bed encasing according to claim 24, wherein said nonwoven textile structure is selected from the group consisting of; carded web nonwoven textile structures, spun bonded nonwoven textile structures, point bonded nonwoven textile structures and needle punched nonwoven textile structures.

26. The animal bed encasing according to claim 1, further including a backing material disposed adjacent to the odor adsorbing layer at a position below the face textile, wherein said backing material is a textile material and wherein said textile material is a knitted textile structure.

27. The animal bed encasing according to claim 26, wherein said knitted textile structure is formed from a plurality of fibers selected from the group consisting of; cotton fibers, linen fibers, polyester fibers, nylon fibers, acrylic fibers, rayon fibers, polypropylene fibers, polyethylene fibers and blends thereof.

28. The animal bed encasing according to claim 1, further including a backing material disposed adjacent to the odor adsorbing layer at a position below the face textile, wherein said backing material comprises a film.

29. The animal bed encasing according to claim 28, wherein said film is substantially liquid impermeable.

30. The animal bed encasing according to claim 28, wherein said film comprises a polyethylene film.

31. A method of forming an animal bed encasing, the method comprising:
providing a face textile having an exterior surface and an interior surface wherein the face textile is selected from the group consisting of a woven textile material, a knitted textile material and a nonwoven textile material;
mechanically treating the exterior surface of said face textile by one or more surface treatment processes selected from the group consisting of calendering, embossing, metalization, heat setting, sanforizing, glazing, schreinering, sanding, emorizing, napping, shearing, tigering, decating, and crepe fabric patterning; and
disposing the face textile in adjacent contacting relation with an odor receiving layer such that the odor receiving layer is disposed on the interior surface of the face textile, wherein the odor receiving layer comprises a plurality of odor receiving particles selected from the group consisting of activated carbon and activated charcoal held in place by a bonding adhesive and wherein at least a portion of the odor receiving particles are disposed in contacting relation with the interior surface.

32. The method as recited in claim 31, comprising the further step of printing a pattern across the exterior surface of the face textile.

33. The method as recited in claim 32, wherein the printing step is carried out by a process selected from the group consisting of transfer printing, screen printing, flexographic printing, digital printing and ink jet printing.

34. The method as recited in claim 31, comprising the further steps of providing a backing material and disposing said backing material adjacent to the odor adsorbing layer at a position below the face textile.

35. The method as recited in claim 34, wherein said backing material comprises a textile material.

36. The method as recited in claim 35, wherein said textile material is a woven textile structure.

37. The method as recited in claim 36, wherein said woven textile structure is formed from a plurality of fibers selected from the group consisting of; cotton fibers, linen fibers, polyester fibers, nylon fibers, acrylic fibers, rayon fibers, polypropylene fibers, polyethylene fibers and blends thereof.

38. The method as recited in claim 35, wherein said textile material is a nonwoven textile structure.

39. The method as recited in claim 38, wherein said nonwoven textile structure is formed from a plurality of fibers selected from the group consisting of; cotton fibers, linen fibers, polyester fibers, nylon fibers, acrylic fibers, rayon fibers, polypropylene fibers, polyethylene fibers and blends thereof.

40. The method as recited in claim 38, wherein said nonwoven textile structure is selected from the group consisting of; carded web nonwoven textile structures, spun bonded nonwoven textile structures, point bonded nonwoven textile structures and needle punched nonwoven textile structures.

41. The method as recited in claim 35, wherein said textile material is a knitted textile structure.

42. The method as recited in claim 41, wherein said knitted textile structure is formed from a plurality of fibers selected from the group consisting of; cotton fibers, linen fibers, polyester fibers, nylon fibers, acrylic fibers, rayon fibers, polypropylene fibers, polyethylene fibers and blends thereof.

43. The method as recited in claim 35, wherein said backing material comprises a film.

44. The method as recited in claim 43, wherein said film is substantially liquid impermeable.

45. The method as recited in claim 44, wherein said film comprises a polyethylene film.

46. A method of forming an animal bed, the method comprising:
providing a face textile having an exterior surface and an interior surface wherein the face textile is selected from the group consisting of a woven textile material, a knitted textile material and a nonwoven textile material;
disposing the face textile in adjacent contacting relation with an odor receiving layer such that the odor receiving layer is disposed on the interior surface of the face textile, wherein the odor receiving layer comprises a plurality of odor receiving particles selected from the group consisting of activated carbon and activated charcoal held in place by a bonding adhesive and wherein at least a portion of the odor receiving particles are disposed in contacting relation with the interior surface; and
disposing the face textile and adjacent odor receiving layer in at least partially covering relation to a cushioning core, wherein the face textile, odor receiving layer and cushioning core are all substantially free of microbe-inhibiting additives.
